(19) United States
(12) Patent Application Publication
(10) Pub. No.: US 2026/0154186 A1
(43) Pub. Date: Jun. 4, 2026

(54) System, Method, and Device for Automating Testing in A Mainframe Environment

(71) Applicant: The Toronto-Dominion Bank, Toronto (CA)

(72) Inventors: Arthur Yan-Kiu SIT, Mississauga (CA); Craig Edward Jason MYERS, Oshawa (CA)

(73) Assignee: The Toronto-Dominion Bank, Toronto (CA)

(21) Appl. No.: 18/964,170

(22) Filed: Nov. 29, 2024

(51) Int. Cl. G06F 11/3668; G06F 40/205

(52) U.S. Cl. CPC G06F 11/3688; G06F 11/3684; G06F 11/3692; G06F 40/205

(57) ABSTRACT

System, method and device for automating testing in a mainframe environment. The method includes providing a mainframe module, receiving a request to automate testing with one or more test parameters on a mainframe in communication with the device, and generating a job manifest, based on the test parameters, to perform the automated testing requested within a mainframe testing environment. The method also includes generating a set of mainframe readable instructions to perform the job manifest in the mainframe testing environment; and transmitting the set of mainframe readable instructions via the mainframe module to the mainframe to automate testing.

### TECHNICAL FIELD

The following relates generally to methods for automating testing, and more specifically to automating testing in a mainframe environment.

### BACKGROUND

Despite being a relatively old technology, mainframes continue to be prominent in certain businesses for certain applications. Mainframes can be used for sensitive applications, and as a result of their relative longevity and lack of testing, they can run dated processes that are hard to understand for unfamiliar users.

As a result of their relative scarcity, the sensitivity of the information processed, and the specificity of the application, testing within mainframe environments is challenging. For example, the expertise required to test in a mainframe environment can be scarce, both in terms of interacting with a mainframe specifically, and with respect to interacting with potentially large amounts of legacy jobs and processes that have been maintained on the mainframe given their longevity. Mainframes, as a result of the sensitive data they process, can have strict access protocols reducing access to testing generally.

Testing in a mainframe environment is also difficult because it is difficult to find and use appropriate data. Testing is usually performed on any available data, and extracting data that is comparable to the data that would be needed for testing a specific job (e.g., a particular transaction) may require performing a plurality of preparatory steps and processing (increasing the difficulty associated with scheduling and performing the testing). For example, the available data can monthly data, whereas monthly jobs are not typically executed in the production environment.

Unlike more modern computing architecture, and a factor in introducing friction to using mainframes more generally, mainframes can have limited and archaic user interfaces. These user interfaces can preclude a more widespread ability to interact with and design testing for mainframe environments.

### BRIEF DESCRIPTION OF THE DRAWINGS

Embodiments will now be described with reference to the appended drawings wherein:

FIG. 1 is a schematic diagram of an example computing environment.

FIG. 2 is a block diagram of an example configuration of a mainframe testing environment.

FIG. 3 is a block diagram of an example configuration for an enterprise system having a mainframe.

FIG. 4a illustrates a series of jobs and snapshots obtained at certain points along the job sequence.

FIG. 4b illustrates a series of jobs having branches and snapshots obtained at certain points along branches of the job sequence.

FIG. 5 is a flow diagram illustrating a process flow for utilizing snapshots of job data.

FIG. 6 is a flow diagram illustrating operations that may be executed in building a job manifest.

FIG. 7 is a block diagram of an example configuration of a client device used to interface with, for example, the mainframe testing environment.

FIG. 8 is a flow chart illustrating example operations that may be performed in automating testing in a mainframe environment.

FIG. 9 is a flow chart illustrating example operations that may be performed in processing data snapshots in automated mainframe testing.

FIG. 10 is a flow chart illustrating example operations that may be performed in extracting and saving data snapshots of jobs in a process.

FIG. 11 is a flow chart illustrating example operations that may be performed in using a data snapshot to populate job manifests.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The following generally relates to a testing process that allows for a user to execute and test large amount of business processing jobs to validate code differences, e.g., within a mainframe.

Currently, tools are lacking for validating batch jobs. Normally, such testing is done monthly or daily with any useable data that is available. The data, however, currently does not age in a testing environment (e.g., when testing credit card numbers assigned to a test environment), since the daily and monthly jobs are not typically executed in the testing environment.

Challenges exist in how to efficiently and cost effectively validate data, e.g., for code changes, on batch jobs, in a reasonably frequent manner.

The processes described herein provide a testing process that allows for a user to execute and test large amount of business processing jobs to validate code differences. This process may allow the testing organization to easily determine processing differences on the same data set across production jobs and jobs in development/test.

The mainframe module described herein may be designed to determine processing differences in various circumstances and to provide certain features, such as:
a) In production, at different points during a stream of jobs, capture a dataset.
b) In the environment under test, indicate which set of jobs to execute.
c) Process automatically creates Mainframe Job Control Language (JCL) Jobs.
d) Process automatically submits sets of jobs to reset data.
e) Process automatically compares the test results with the reset data.
f) User is provided with an indication of job executions and test results.

A difficulty in testing in the lower environments is the data. In production, many jobs are executed to ensure business processes are maintained. The solution herein may capture data snapshots throughout the stream of jobs being executed. The system may then use the snapshots as entry points in testing job streams. These snapshots allow the testing organization to quickly test jobs in a job stream automatically.

As described below, an automated process may be triggered by a single tester. What traditionally would take multiple testers to capture the right state of data and the related job streams, can be done through this automated process by that single person.

This process may automatically determine which snapshot should be selected based on where the selected job sits in a job stream. This process may also automatically compile all the jobs necessary to execute to bring the test data to a state that the job under test can be executed successfully. Finally, the process may formulate programmatically all the jobs such that they can be executed in the environment under test.

According to one aspect, a device for automating testing in a mainframe environment is disclosed. The device includes a processor, a communication module coupled to the processor, and a memory coupled to the processor. The memory stores computer executable instructions that when executed by the processor cause the processor to provide a mainframe module; receive a request to automate testing with one or more test parameters on a mainframe in communication with the device; generate a job manifest, based on the test parameters, to perform the automated testing requested within a mainframe testing environment; generate a set of mainframe readable instructions to perform the job manifest in the mainframe testing environment; and transmit the set of mainframe readable instructions via the mainframe module to the mainframe to automate testing.

In certain example embodiments, to generate the job manifest, the instructions cause the processor to determine a data snapshot relevant to the request; and wherein the mainframe readable instructions are generated to populate a mainframe test environment with the determined data snapshot.

In certain example embodiments, the mainframe module is stored on the device and comprises a plurality of mappings between mainframe jobs and request parameters.

In certain example embodiments, the mainframe module generates the job manifest and the mainframe readable instructions based on the plurality of mappings.

In certain example embodiments, the plurality of mappings include mappings of functions from a first programming language to mainframe job control language of the mainframe.

In certain example embodiments, the mainframe readable instructions are generated to be interpretable by a channel of communication with the mainframe that avoids a user interface of the mainframe.

In certain example embodiments, to generate the job manifest, the instructions cause the processor to parse the request and the one or more test parameters to determine one or more applicable jobs; determine one or more prerequisite jobs associated with the one or more applicable jobs; and populate the job manifest with the one or more applicable jobs and the one or more pre-requisite jobs.

In certain example embodiments, to populate the job manifest, the instructions cause the processor to populate the job manifest with the one or more applicable jobs and the one or more pre-requisite jobs subsequent to a determined data snapshot relevant to the request.

In certain example embodiments, to generate the mainframe readable instructions, the instructions cause the processor to: populate the mainframe readable instructions with instructions to: generate a reference job manifest that processes the data snapshot without the test parameters; load a test environment on the mainframe with the determined data snapshot; execute the reference job manifest with the determined data snapshot; reload the test environment with the determined data snapshot and execute the job manifest; and compare the results of the reference job manifest and the job manifest.

In certain example embodiments, the instructions further cause the processor to: generate another set of mainframe interpretation instructions that cause the mainframe to: perform a plurality of jobs; at pre-determined positions of the plurality of jobs, extract a plurality of data snapshots; store the plurality of data snapshots; and update the mainframe module based on the plurality of data snapshots.

In certain example embodiments, the instructions further cause the processor to perform one or more anonymization operations to snapshot data prior to storing data snapshots in the plurality of snapshots.

In certain example embodiments, the mainframe module is stored at least in part on a separate database, and requests are received via a user interface of the mainframe module.

In certain example embodiments, the user interface of the mainframe module generates alerts in response to determining a request cannot be performed on the mainframe.

In another aspect, a method for automating testing in a mainframe environment is disclosed. The method includes providing a mainframe module; receiving a request to automate testing with one or more test parameters on a mainframe in communication with the device; generating a job manifest, based on the test parameters, to perform the automated testing requested within a mainframe testing environment; generating a set of mainframe readable instructions to perform the job manifest in the mainframe testing environment; and transmitting the set of mainframe readable instructions via the mainframe module to the mainframe to automate testing.

In certain example embodiments, the method includes determining a data snapshot relevant to the request; and populating the mainframe readable with instructions to populate a mainframe test environment with the determined data snapshot.

In certain example embodiments, the mainframe module is stored on the device and comprises a plurality of mappings between mainframe jobs and request parameters.

In certain example embodiments, the method includes populating the job manifest with the one or more applicable jobs and the one or more pre-requisite jobs subsequent to a determined data snapshot relevant to the request.

In certain example embodiments, the method includes populating the mainframe readable instructions with instructions to: generate a reference job manifest that processes a determined data snapshot without the test parameters; to load a test environment on the mainframe with the determined data snapshot; execute the reference job manifest with the determined data snapshot; reload the test environment with the determined data snapshot and execute the job manifest; and compare the results of the reference job manifest and the job manifest.

In certain example embodiments, the method includes generating another set of mainframe interpretation instructions that cause the mainframe to: perform a plurality of jobs; at pre-determined positions of the plurality of jobs, extract a plurality of data snapshots; store the plurality of data snapshots; and update the mainframe module based on the plurality of data snapshots.

In another aspect, a non-transitory computer readable medium for automating testing in a mainframe environment is disclosed. The computer readable medium comprises computer executable instructions for providing a mainframe module; receiving a request to automate testing with one or more test parameters on a mainframe in communication with the device; generating a job manifest, based on the test parameters, to perform the automated testing requested within a mainframe testing environment; generating a set of mainframe readable instructions to perform the job manifest in the mainframe testing environment; and transmitting the set of mainframe readable instructions via the mainframe module to the mainframe to automate testing.

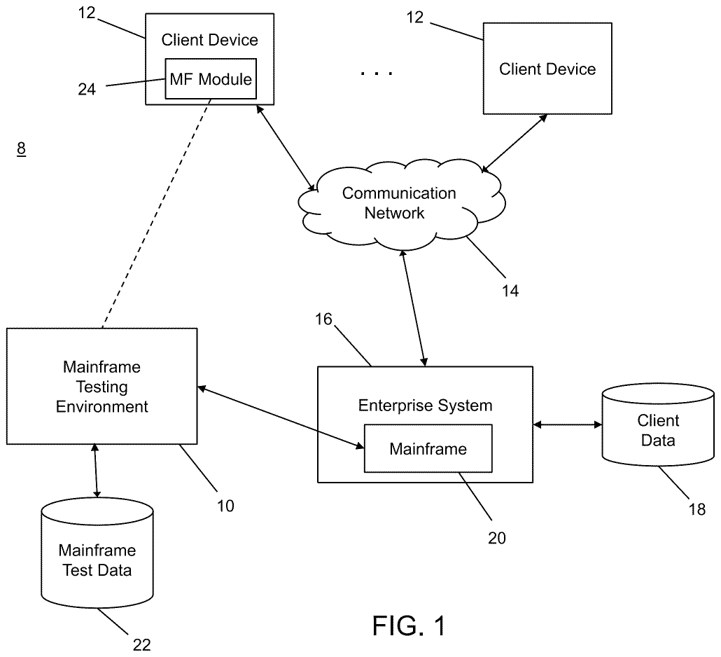

Referring now to the figures, FIG. 1 illustrates an example of a computing environment 8. In one aspect, the computing environment 8 may include one or more client devices 12, and one or more communications networks 14 connecting the components of the computing environment 8. The client devices 12 may include or otherwise have access to a mainframe (MF) module 24. The module 24 may be used to communicate with a mainframe testing environment 10 via the communication network 14 or directly, e.g., when located in a same local environment within the computing environment 8.

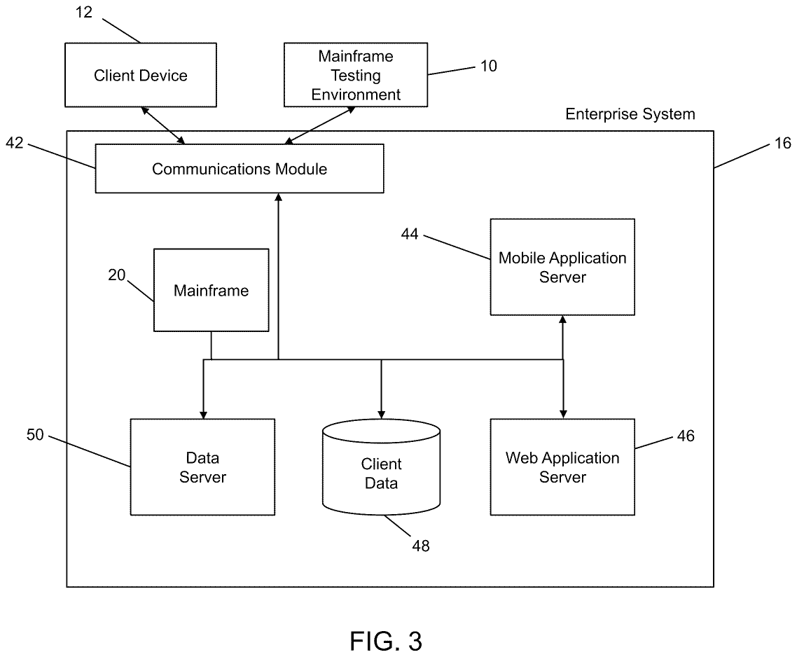

The computing environment 8 may also include an enterprise system 16 (e.g., a financial institution such as commercial bank and/or insurance provider) that provides financial services accounts to users and processes financial transactions associated with those financial service accounts. While several details of the enterprise system 16 have been omitted for clarity of illustration, reference will be made to FIG. 3 below for additional details. The enterprise system 16 includes, at least in part, a mainframe 20. The mainframe 20, as known in the art, may be or comprise one or more high-performance computers designed to handle and process vast amounts of data quickly and reliably. These computers are typically used for large-scale transaction processing, critical applications, and bulk data processing tasks.

The enterprise system 16 includes or otherwise has access to a datastore for storing client data 18. The enterprise system 16 may include other datastores not shown in FIG. 1. The data associated with a user can include client profile data that may be mapped to corresponding financial data for that user. It can be appreciated that the financial data could also include transaction data and/or the client data 18 shown in FIG. 1 and these datastores are described separately for illustrative purposes. The client data 18 can include both data that is associated with a client as well as data that is associated with one or more user accounts for that client as recognized by the computing environment 8.

The data associated with a client may include, without limitation, demographic data (e.g., age, gender, income, location, etc.), preference data input by the client, and inferred data generated through machine learning, modeling, pattern matching, or other automated techniques. The client data 18 may also include historical interactions and transactions associated with the enterprise system 16, e.g., login history, search history, communication logs, documents, etc.

Client devices 12 may be associated with one or more users. Users may be referred to herein as customers, clients, policy holders, correspondents, or other entities that interact with the enterprise system 16 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with a mobile or web-based financial (banking) application which uses or incorporates subsystems of the enterprise system 16, discussed further below.

The client devices 12 can access information within the mainframe testing environment 10 and/or enterprise system 16 or another remote computing environment associated with the enterprise system 16 in a variety of ways. For example, the client device 12 can access the mainframe testing environment 10 or enterprise system 16 via a web-based application, or a dedicated application. Access can require the provisioning of different types of credentials (e.g., login credentials, two factor authentication, etc.). In example embodiments, each different device 12 can be provided with a unique degree of access, or variations thereof. For example, the client device 12 can be provided with a greater degree of access to the enterprise system 16 compared to other devices such as point of sale (POS) devices.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The enterprise system 16 can be understood to encompass the whole of the enterprise, a subset of a wider enterprise system (not shown), such as a system serving a subsidiary, or a system for a particular branch or team of the enterprise (e.g., a resource migration division of the enterprise). In at least one example embodiment, the enterprise system 16 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc. Financial institutions can generate vast amounts of data, and have vast amounts of existing records, both of which can be difficult to migrate into a digital and remote computing environment.

The enterprise system 16 may include both on-premises and remote computing assets provided by a remote computing environment - not shown (hereinafter referred to in the alternative as computing resources). The remote computing environment includes resources used by, or available, to the enterprise system 16 that are stored or managed by a party other than operator of the enterprise system 16. For example, the computing resources can include cloud-based storage services (e.g., database(s)). In at least some example embodiments, the computing resources include one or more tools developed or hosted by the external party, or tools for interacting with the computing resources. In at least one contemplated embodiment, the tool (referred to in the singular for ease of reference) is a tool for managing data lakes, and more specifically a tool for scheduling writing to a data lake associated with the Microsoft TM Azure TM data storage and processing platform. Further particularizing the example, the tool can allow a client device 12 to access the computing resources, and to thereafter configure an ingestion procedure wherein different data files are assigned to different processors (e.g., hardware) within the computing resources based on a configuration file. The tool can be or include aspects of a machine learning tool, or a tool associated with the Delta Lake Storage (ALDS)™ suite, etc. The computing resources can also include hardware resources, such as access to processing capability of server devices (e.g., cloud computing), and so forth.

The mainframe testing environment 10 is shown as a separate entity in FIG. 1 for illustrative purposes and, in other configurations, may be part of or otherwise integrated into/with the enterprise system 16. As shown in FIG. 1, the mainframe testing environment 10 may be coupled to or in communication with the mainframe 20 to permit the mainframe module 24 to execute testing on jobs or tasks in the mainframe 20, e.g., using the client device 12.

Referring back to FIG. 1, the enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the enterprise system 16. The cryptographic server may be used to protect the financial data and/or client data 18 by way of encryption for data protection, digital signatures or message digests for data integrity, and by using digital certificates to authenticate the identity of the users and client devices 12, POS devices 10, with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

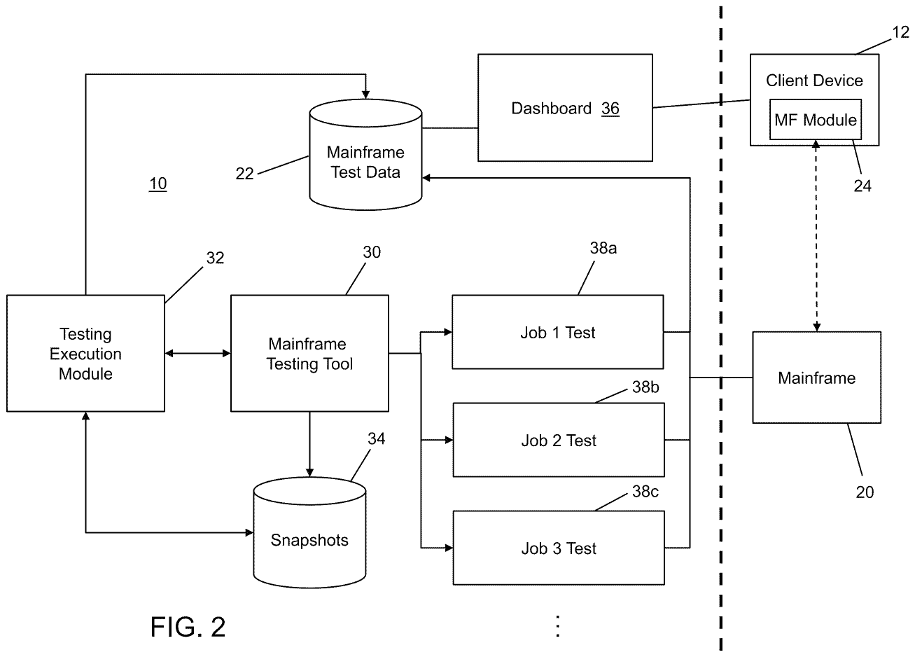

Turning now to FIG. 2, an example configuration of the mainframe testing environment 10 is shown. The mainframe testing environment 10 may include a testing environment interface (not shown), which can be coupled to an application development environment and/or application deployment environment. Such a testing environment interface can provide a UI for personnel or administrators in the application testing environment 10 to coordinate an automated build management process as herein described and to initiate or manage a test execution process as herein described. The mainframe testing environment 10 also includes a testing execution module 32 and a mainframe testing tool 30. The testing execution module 32 or mainframe testing tool 30 may provide the testing environment interface mentioned above.

The mainframe 20 may be coupled to the mainframe testing environment 10 to coordinate with the testing execution module 32 to allow the testing execution module 32 to execute Job tests 38a, 38b, 38c, . . . , to evaluate metrics, for example, by executing tests in or related to the mainframe 20. The tests 38 can generate data logs, reports and other outputs, stored as mainframe test data 22, which can be made available to various entities or components, such as a dashboard 36.

It can be appreciated that while the testing execution module 32 and mainframe testing tool 30 are shown as separate modules in FIG. 2, such modules may be combined in other configurations and thus the delineations shown in FIG. 2 are for illustrative purposes.

FIG. 2 provides an example of a configuration for the testing execution module 32 to generate test results. The testing execution module 32 is coupled to the mainframe testing tool 30 to initiate and coordinate testing of mainframe jobs, as discussed above. This may include accessing data in the mainframe 20. The mainframe testing tool 30 includes or has access to snapshots 62, which capture points in a sequence of jobs to permit testing data in the mainframe 20. Execution of the jobs 60 may generate logs, reports, or other data associated with a test and stored by the mainframe testing tool 30 for and/or during a test. While performing these tests 38, the mainframe testing tool 30 not only generates mainframe test data 22 but can also store session details. The testing execution module 32 can access the session details to determine performance measures associated with performing the tests 38. This can be visualized using the dashboard 36, reported back to the development environment or enterprise system 16, or itemized, documented or specified in any other suitable manner.

The testing execution module 32 can be configured to automate the tasks necessary to monitor and capture the application traffic logs in the mainframe 20. The testing execution module 32 can trigger the respective business flow on the application under test, and alongside, a proxy tool would capture the logs being made for each user action such as launching app, clicking login, clicking on an account registered for a user ID, etc. Upon completion of the business flow, the corresponding file containing the logs can be downloaded by navigating to a URL provided by the proxy tool web interface. This process would be performed for the remaining flows in the test suite. In the example configuration shown in FIG. 2, the downloaded data can be stored as mainframe test data 22 (e.g., session details).

In FIG. 3, an example configuration of an enterprise system 16 is shown. The enterprise system 16 includes a communications module 42 that enables the enterprise system 40 to communicate with one or more other components of the computing environment 8, such as the mainframe testing environment 10, via a bus or other communication network, such as the communication network 14. While not delineated in FIG. 3, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 3 illustrates examples of servers and datastores/databases operable within the enterprise system 16. It can be appreciated that any of the components shown in FIG. 3 may also be hosted externally and be available to the enterprise system 16, e.g., via the communications module 42. In the example embodiment shown in FIG. 3, the enterprise system 16 includes one or more servers to provide access to client data 48, e.g., for development or testing purposes. Exemplary servers include a mobile application server 44, a web application server 46 and a data server 50. The enterprise system 16 also includes the mainframe 20 that is subjected to testing as described herein. Although not shown in FIG. 3, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storage elements for storing and providing data for use in such services, such as data storage for storing client data 48.

Mobile application server 44 supports interactions with a mobile application installed on client device (which may be similar or the same as a test device). Mobile application server 44 can access other resources of the enterprise system 16 to carry out requests made by, and to provide content and data to, a mobile application on client device. In certain example embodiments, mobile application server 44 supports a mobile banking application to provide payments from one or more accounts of user, among other things.

Web application server 46 supports interactions using a website accessed by a web browser application running on the client device. It can be appreciated that the mobile application server 44 and the web application server 46 can provide different front ends for the same application, that is, the mobile (app) and web (browser) versions of the same application. For example, the enterprise system 16 may provide a banking application that be accessed via a smartphone or tablet app while also being accessible via a browser on any browser-enabled device.

The client data 48 can include, in an example embodiment, financial data that is associated with users of the client devices (e.g., customers of the financial institution). The financial data may include any data related to or derived from financial values or metrics associated with customers of a financial institution system (i.e. the enterprise system 16 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

It will be appreciated that only certain modules, applications, tools and engines are shown in FIGS. 2 and 3 for ease of illustration and various other components would be provided and utilized by the mainframe testing environment 10 and enterprise system 16, as is known in the art.

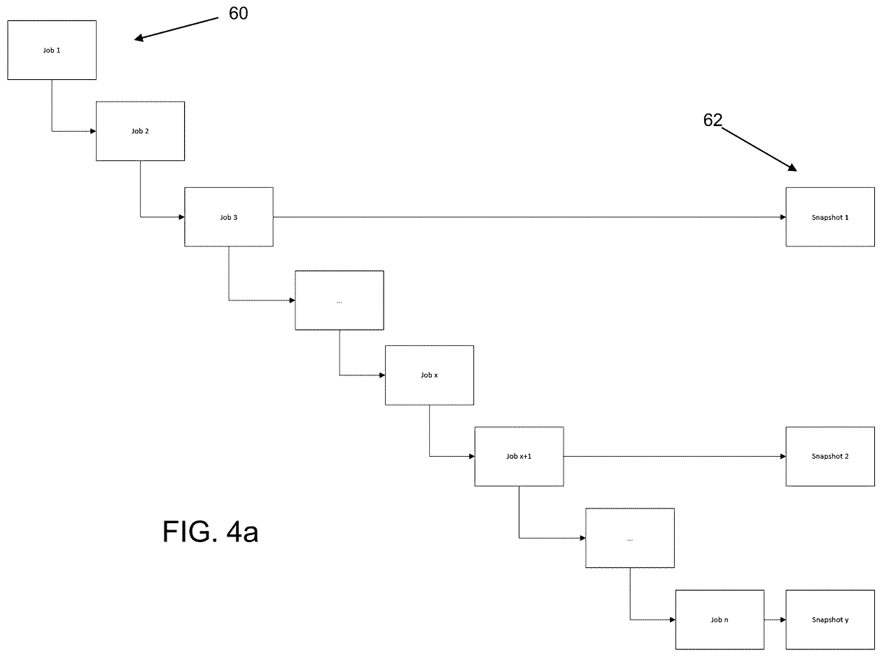

Referring now to FIG. 4a, a series of mainframe jobs 60 is shown. In production, particularly in a mainframe 20, many jobs 60 are executed to ensure business processes are maintained. As shown in FIG. 4a, data snapshots 62 are captured throughout the stream of jobs 60 being executed. The mainframe testing environment 10, e.g., under the direction of the mainframe module 24 may then use the snapshots 62 as entry points in testing job streams. This is illustrated in FIG. 4a, in which Snapshot 1 and Snapshot 2 are taken at certain points in the flow. By associating the snapshots 62 with the point at which they are taken (e.g., which job 60), updates to the mainframe 20 may be more efficiently tested since certain jobs 60 before or after the snapshot 62 may or may not be affected by the changes. This allows a mainframe 20 to be tested more frequently when compared to monthly or weekly batch jobs that are often used given the high volume of data being processed as well as the potential complexity of the job streams. That is, the snapshots 62 allow the testing organization (e.g., mainframe testing environment 10) to quickly test jobs in a job stream automatically since the snapshots 62 may be referenced, which in turn determines the point in the stream where the snapshot was taken to allow the mainframe testing environment 10 to isolate and target different areas of the job stream in an automated fashion.

FIG. 4b illustrates that job streams can be branched thus introducing further complexity into the testing design and execution. By taking snapshots 62 at strategic spots in these branches, the mainframe testing environment 10 can target or isolate branches or otherwise determine the upstream impact on downstream snapshots 62.

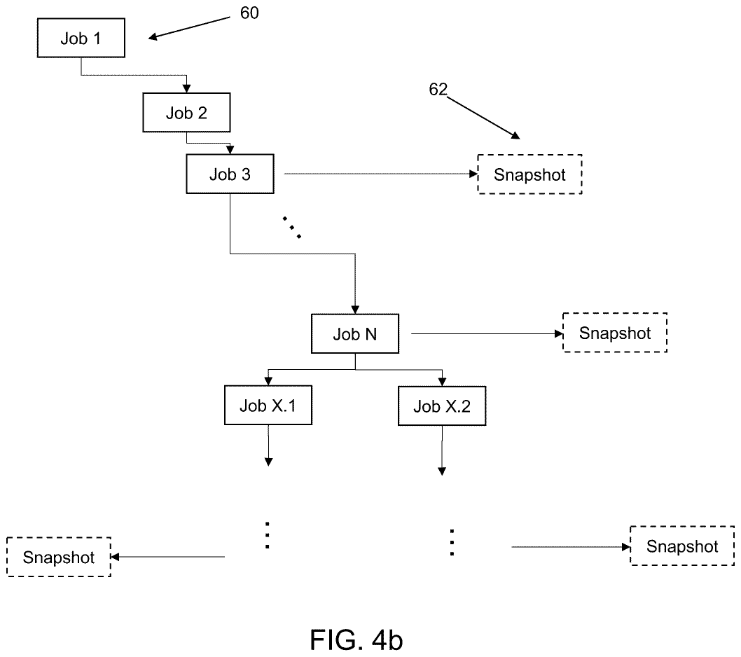

A process flow for utilizing the snapshot(s) 62 is shown in FIG. 5.

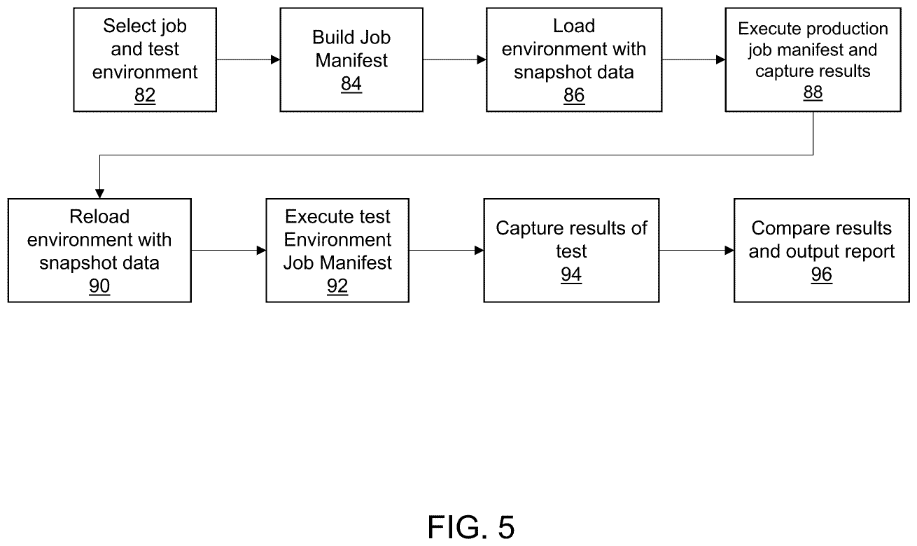

The mainframe module 24 may be used to select a job 60 and test the mainframe 20 (or other environment, e.g., other portion of the enterprise system 16) at stage 82. A job manifest is then built at stage 84 (see also FIG. 6 described below). The testing environment 10 may be loaded with the snapshot data at stage 86, which allows the mainframe module 24 to execute a production job manifest and capture results at stage 88. This generates a comparison point for testing using the testing environment job manifest. That is, the mainframe testing environment 10 may then be reloaded with the snapshot data at stage 90 and execute a test environment job manifest at stage 92. The results of this second testing stage are captured at stage 94. This enables the mainframe job stream to be compared before and after the changes, by accessing the snapshots 62 at the appropriate stage in order to determine how the changes affect the job stream. The results may therefore be compared to each other, and an output report generated at stage 96.

This automated process can be triggered by a single tester. What traditionally would take multiple testers to capture the right state of data and the related job streams, can be done through this automated process by that single person.

Referring now to FIG. 6, stage 84 shown in FIG. 5, which is used to build the job manifest is shown in greater detail. It can be appreciated that the process shown in FIG. 6 may automatically determine which snapshot 62 should be selected based on where the selected job 60 sits in a job stream. This process also automatically compiles all the jobs 60 necessary to execute to bring the test data to a state that the job 60 under test can be executed successfully. Finally, this process formulates programmatically, all the jobs such that they can be executed in the environment under test.

As shown in FIG. 6, to build the job manifest, the mainframe module 24 may determine the prerequisite jobs at stage 100 and, from the prerequisite jobs, determine the snapshot 62 or point in the process to be used at stage 102. The mainframe module 24 may then create a local copy of a job mapper, e.g., using a mainframe job control language (JCL) at stage 104. The production JCL jobs may be updated in the list with test environment parameters, namely the parameters for executing the tests 38, at stage 106.

At stage 108, a production job manifest is generated. This is used to create a local copy of the test environment JCL jobs at stage 110. The test JCL jobs are then updated in the list with the test environment parameters at stage 112, to generate the test environment job manifest at stage 114. The test environment job manifest may be used as shown in FIG. 5.

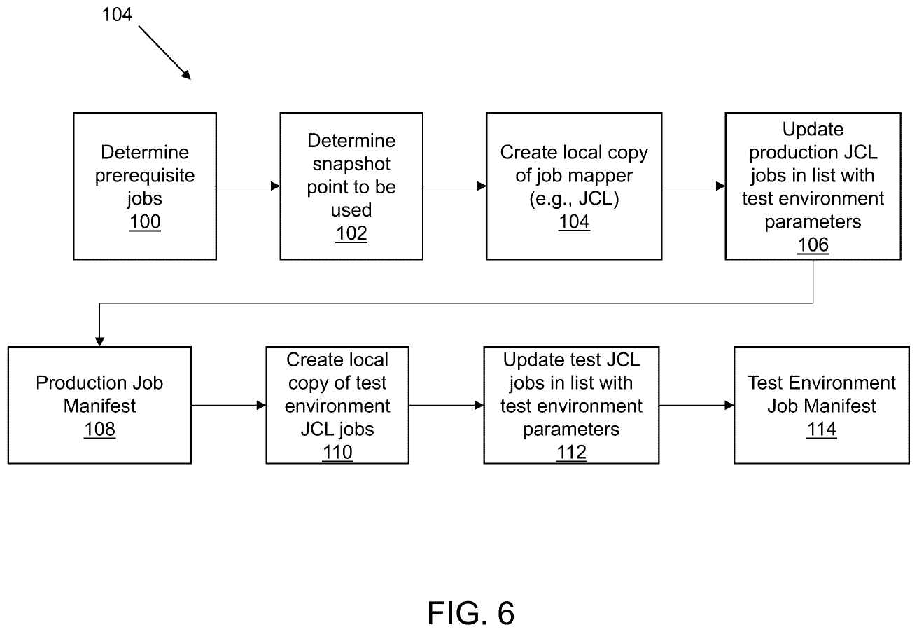

In FIG. 7, an example configuration of a client device 12 is shown. In certain embodiments, the client device 12 may include one or more processors 130, a communications module 132, and a data store 144 storing device data 146 and application data 148. Communications module 132 enables the client device 12 to communicate with one or more other components of the computing environment 8, such as the mainframe testing environment 10, via a bus or other communication network, such as the communication network 14. While not delineated in FIG. 7, the client device 12 includes at least one memory or memory device that can include a tangible and non-transitory computer-readable medium having stored therein computer programs, sets of instructions, code, or data to be executed by processor 130. FIG. 7 illustrates examples of modules and applications stored in memory on the client device 12 and operated by the processor 130. It can be appreciated that any of the modules and applications shown in FIG. 7 may also be hosted externally and be available to the client device 12, e.g., via the communications module 132.

In the example embodiment shown in FIG. 7, the client device 12 includes a display module 134 for rendering GUIs and other visual outputs on a display device such as a display screen, and an input module 136 for processing user or other inputs received at the client device 12, e.g., via a touchscreen, input button, transceiver, microphone, keyboard, etc. The client device 12 may also include the mainframe module 24, which may take the form of a customized app, plug-in, widget, or software component provided by the mainframe testing environment 10 for use by the client device 12 to use in mainframe testing. Similarly, the client device 12 may include an enterprise system application 142 provided by the enterprise system 16. The client device 12 in this example embodiment also includes a web browser application 140 for accessing Internet-based content, e.g., via a mobile or traditional website. The data store 144 may be used to store device data 146, such as, but not limited to, an IP address or a MAC address that uniquely identifies client device 12 within environment 8. The data store 144 may also be used to store application data 148, such as, but not limited to, login credentials, user preferences, cryptographic data (e.g., cryptographic keys), etc.

It will be appreciated that only certain modules, applications, tools and engines are shown in FIGS. 1 to 3 and 7 for ease of illustration and various other components would be provided and utilized by the mainframe testing environment 10, mainframe module 24, client device 12, and enterprise system 16 as is known in the art.

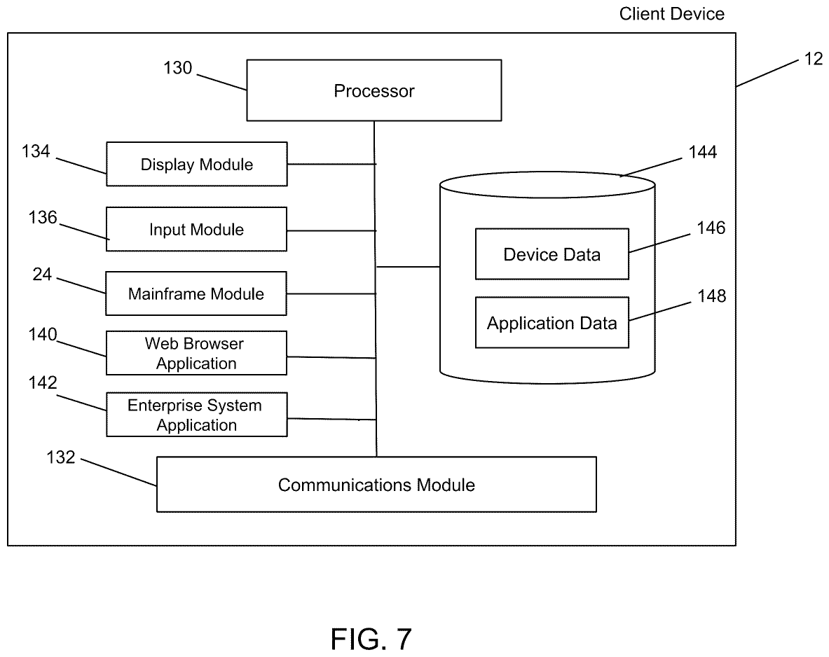

Referring now to FIG. 8, a flow chart illustrates operations that may be performed in automating testing of a mainframe 20 in a mainframe testing environment 10. At block 200, a mainframe module 24 may be provided, e.g., as shown in FIGS. 1 and 2, to enable a user of a client device 12 to communicate with the mainframe testing environment 10.

At block 202, a request is received to automate testing with one or more test parameters associated with the mainframe 20, one or more of the jobs 60 and/or the test(s) 38. The request may be received by the mainframe module 20 (e.g., on a client device 12) or otherwise by a device being used to execute testing operations in the mainframe testing environment 10 (e.g., as shown in FIG. 2.)

At block 204, a job manifest may be generated based on the test parameters, e.g., as shown in FIGS. 5 and 6, to perform the automated testing requested within the mainframe testing environment 10. At block 206, a set of mainframe readable instructions (e.g., JCL instructions) are generated to perform the job manifest in the mainframe testing environment 10.

At block 208, the set of mainframe readable instructions are transmitted via the mainframe module 24 to the mainframe 20 (e.g., with or via the mainframe testing environment 10) to automate the testing, e.g., as shown in FIGS. 5 and 6.

As shown in FIG. 8, optionally, as illustrated using dashed lines, a data snapshot 62 (e.g., saved in database 34) may be determined, which is relevant to the request. In this way, the snapshot 62 may be used to targe a particular portion of the job stream to compare changes to what would be implemented in a production environment.

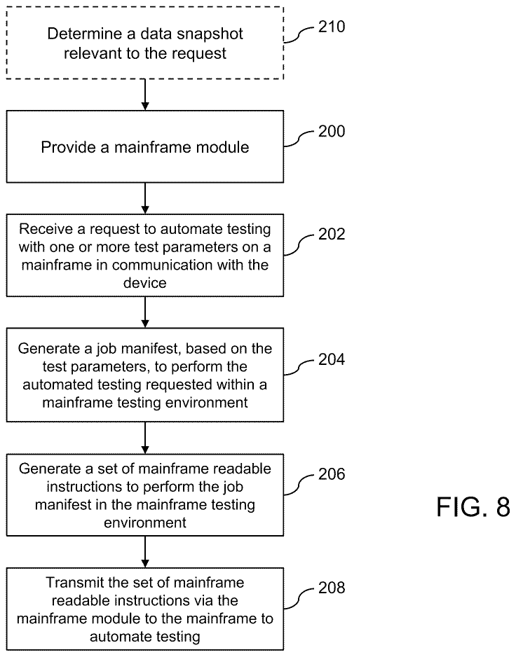

Referring now to FIG. 9, a flow chart is provided illustrating example operations that may be performed in processing data snapshots in automated mainframe testing. At block 220, a reference job manifest may be generated, which processes a data snapshot 62 without the test parameters. At block 222, the test execution module 32 may load a test environment on the mainframe 20 with the determined data snapshot 62. Then, at block 224, the reference job manifest may be executed with the determined data snapshot 62.

At block 226, the main frame test environment 10 (e.g., using the mainframe module 24) reloads the test environment 10 with the determined data snapshot 62 and executes the job manifest, in order to compare the results of the reference job manifest with the actual job manifest.

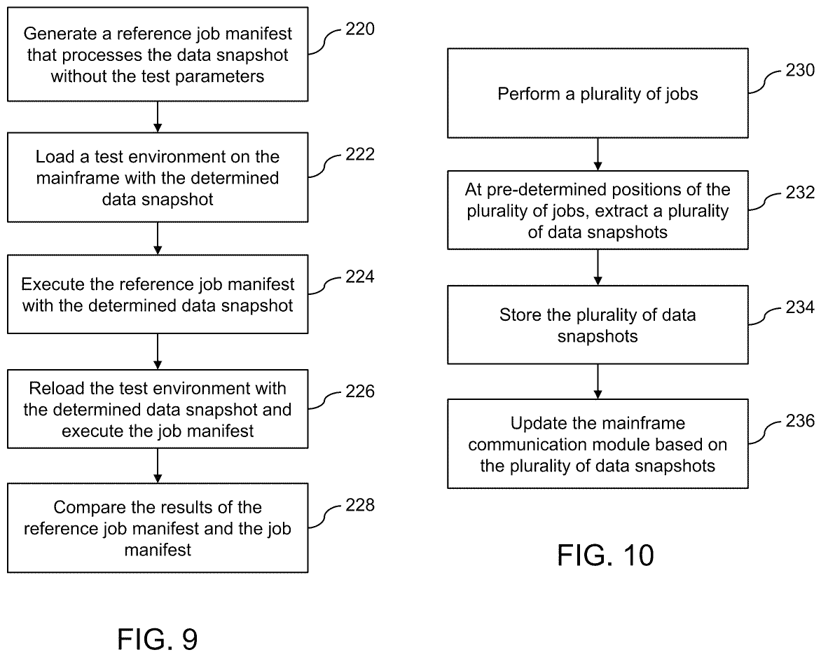

FIG. 10 is a flow chart illustrating example operations that may be performed in extracting and saving data snapshots 62 of jobs 60 in a process. At block 230 a plurality of jobs 60 are performed, e.g., as illustrated in FIGS. 4a and 4b. At block 232, at predetermined positions of the plurality of jobs 60, a plurality of data snapshots 62 are extracted. These may be stored in the database 34 at block 234. At block 236, the mainframe module 24 may be updated based on the plurality of data snapshots 62, e.g., to enable the mainframe module 24 to rely on the snapshots 62 in executing automated testing in the mainframe testing environment 10 by having access to reference points in the process as captured by the respective snapshots 62.

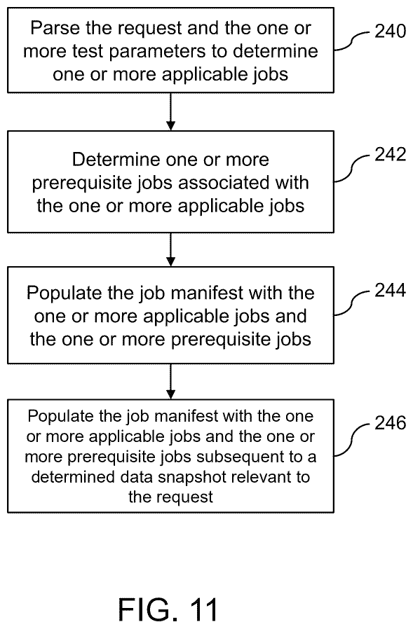

FIG. 11 is a flow chart illustrating example operations that may be performed in using a data snapshot 62 to populate job manifests.

At block 240, the request to perform testing and the test parameter(s) may be parsed to determine the one or more applicable jobs 60. Then, at block 242, the prerequisite jobs associated with those jobs 60 are determined.

At block 244 the job manifest is populated with the applicable jobs and the prerequisite jobs 60. At block 246, the job manifest is populated with the applicable jobs and the prerequisite jobs subsequent to a determined data snapshot 62 relevant to the request. As such, the snapshot 62 enables the mainframe testing environment 10 to determine how changes after jobs 60 after the snapshot 62 that is positioned up to the point of the request.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in the computing environment 8, or accessible or connectable thereto. Any application or module herein described may be implemented using computer readable/executable instructions that may be stored or otherwise held by such computer readable media.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A device for automating testing in a mainframe environment, the device comprising:
a processor;
a communication module coupled to the processor; and
a memory coupled to the processor, the memory storing computer executable instructions that when executed by the processor cause the processor to:
provide a mainframe module;
receive a request to automate testing with one or more test parameters on a mainframe in communication with the device;
generate a job manifest, based on the test parameters, to perform the automated testing requested within a mainframe testing environment;
generate a set of mainframe readable instructions to perform the job manifest in the mainframe testing environment; and
transmit the set of mainframe readable instructions via the mainframe module to the mainframe to automate testing.

2. The device of claim 1, wherein, to generate the job manifest, the instructions cause the processor to:
determine a data snapshot relevant to the request;
and wherein the mainframe readable instructions are generated to populate a mainframe test environment with the determined data snapshot.

3. The device of claim 1, wherein the mainframe module is stored on the device and comprises a plurality of mappings between mainframe jobs and request parameters.

4. The device of claim 3, wherein the mainframe module generates the job manifest and the mainframe readable instructions based on the plurality of mappings.

5. The device of claim 3, wherein the plurality of mappings include mappings of functions from a first programming language to mainframe job control language of the mainframe.

6. The device of claim 1, wherein the mainframe readable instructions are generated to be interpretable by a channel of communication with the mainframe that avoids a user interface of the mainframe.

7. The device of claim 1, wherein, to generate the job manifest, the instructions cause the processor to:
parse the request and the one or more test parameters to determine one or more applicable jobs;
determine one or more prerequisite jobs associated with the one or more applicable jobs; and
populate the job manifest with the one or more applicable jobs and the one or more pre-requisite jobs.

8. The device of claim 7, wherein, to populate the job manifest, the instructions cause the processor to:
populate the job manifest with the one or more applicable jobs and the one or more pre-requisite jobs subsequent to a determined data snapshot relevant to the request.

9. The device of claim 2, wherein, to generate the mainframe readable instructions, the instructions cause the processor to:
populate the mainframe readable instructions with instructions to:
generate a reference job manifest that processes the data snapshot without the test parameters;
load a test environment on the mainframe with the determined data snapshot;
execute the reference job manifest with the determined data snapshot;
reload the test environment with the determined data snapshot and execute the job manifest; and
compare the results of the reference job manifest and the job manifest.

10. The device of claim 1, wherein the instructions further cause the processor to:
generate another set of mainframe interpretation instructions that cause the mainframe to:
perform a plurality of jobs;
at pre-determined positions of the plurality of jobs, extract a plurality of data snapshots;
store the plurality of data snapshots; and
update the mainframe module based on the plurality of data snapshots.

11. The device of claim 10, wherein the instructions further cause the processor to:
perform one or more anonymization operations to snapshot data prior to storing data snapshots in the plurality of snapshots.

12. The device of claim 1, wherein the mainframe module is stored at least in part on a separate database, and requests are received via a user interface of the mainframe module.

13. The device of claim 1, wherein the user interface of the mainframe module generates alerts in response to determining a request cannot be performed on the mainframe.

14. A method for automating testing in a mainframe environment, the method comprising:
providing a mainframe module;
receiving a request to automate testing with one or more test parameters on a mainframe in communication with a device;
generating a job manifest, based on the test parameters, to perform the automated testing requested within a mainframe testing environment;
generating a set of mainframe readable instructions to perform the job manifest in the mainframe testing environment; and
transmitting the set of mainframe readable instructions via the mainframe module to the mainframe to automate testing.

15. The method of claim 14, comprising:
determining a data snapshot relevant to the request; and
populating the mainframe readable with instructions to populate a mainframe test environment with the determined data snapshot.

16. The method of claim 14, wherein the mainframe module is stored on the device and comprises a plurality of mappings between mainframe jobs and request parameters.

17. The method of claim 14, comprising:
populating the job manifest with the one or more applicable jobs and the one or more pre-requisite jobs subsequent to a determined data snapshot relevant to the request.

18. The method of claim 14, comprising:
populating the mainframe readable instructions with instructions to:
generate a reference job manifest that processes a determined data snapshot without the test parameters;
to load a test environment on the mainframe with the determined data snapshot;
execute the reference job manifest with the determined data snapshot;
reload the test environment with the determined data snapshot and execute the job manifest; and
compare the results of the reference job manifest and the job manifest.

19. The method of claim 14, comprising:
generating another set of mainframe interpretation instructions that cause the mainframe to:
perform a plurality of jobs;
at pre-determined positions of the plurality of jobs, extract a plurality of data snapshots;
store the plurality of data snapshots; and
update the mainframe module based on the plurality of data snapshots.

20. A non-transitory computer readable medium for automating testing in a mainframe environment, the computer readable medium comprising computer executable instructions for:
providing a mainframe module;
receiving a request to automate testing with one or more test parameters on a mainframe in communication with a device;
generating a job manifest, based on the test parameters, to perform the automated testing requested within a mainframe testing environment;
generating a set of mainframe readable instructions to perform the job manifest in the mainframe testing environment; and
transmitting the set of mainframe readable instructions via the mainframe module to the mainframe to automate testing.
